(19) United States
(12) Patent Application Publication
(10) Pub. No.: US 2024/0309845 A1
(43) Pub. Date: Sep. 19, 2024

(54) Alternate Vehicle Energy Source

(71) Applicant: Henri Zreik, Ponte Vedra, FL (US)

(72) Inventor: Henri Zreik, Ponte Vedra, FL (US)

(21) Appl. No.: 18/605,954

(22) Filed: Mar. 15, 2024

Related U.S. Application Data
(63) Continuation of application No. 63/452,528, filed on Mar. 16, 2023.

(51) Int. Cl. F03D 9/25; F03D 9/32

(52) U.S. Cl. CPC F03D 9/25; F03D 9/32; F05B 2220/706

(57) ABSTRACT

The Alternate Vehicle Energy Source is a unique vehicle-mounted mechanism designed to optimally capture the Earth atmospheric air kinetic energy and simultaneously convert it into electrical energy, while the vehicle is in forward motion. The electrical current generated could be used to recharge the electrical or hybrid vehicles' main or auxiliary batteries while the vehicle is in forward motion. The mechanism has two different designs. The invention maximizes the utilization of our atmospheric air's unique characteristics of “Accumulation and Dissipation.” The mechanism is uniquely designed to maximize the air thrust force captured while the vehicle is in forward motion and direct it into a specially designed Central Fan with unique blades. The Central Fan is connected to a permanent magnet wind-to-electric generator. The system could produce a net positive energy.

### FIELD OF INVENTION

Green vehicle energy in the form of wind-to-electric recharging mechanism for electrical or hybrid vehicles while in forward motion, via mounted devices on the vehicle's roof and under the front hood of the vehicle.

### BACKGROUND OF INVENTION

The need to extend the range of electrical vehicles and minimize the charging time, is the main challenge facing the boom of the EVs worldwide. The inconvenience and limited availability of charging stations remains one of the main challenges for added production of electrical vehicles. Having filed on 6 Nov. 2013, a same provisional application under number 61900877, and EFS ID 17335958, titled “Alternative Vehicle Energy Source,” I was deterred by the lack of science supporting such an invention.

Ten years later, and after having built a prototype of the invention, I do have, what I believe is the supporting science explaining the data attained at hand. My invention is capable of generating a net positive electrical energy, thus science is discussed at length, explaining and backing the data attained. The scientific explanations are deduced primarily from firsthand experimentations and numerous design alterations, in order to achieve optimum outcome. Some of the science addressed here may be an enhancement to existing physic laws. The data I gathered backs my scientific explanations as well.

### SUMMARY OF INVENTION

The Alternative Vehicle Energy Source invention is a vehicle mounted mechanism, designed to capture a maximum amount of air while the vehicle is in a forward motion. The captured air is channeled through the Main Air Inlets and Auxiliary Air Chutes onto specially designed fans with unique blades configuration. The Auxiliary Air Chutes are designed to accumulate a maximum amount of air, while producing a squeeze effect at the exit end of said chutes, revealing the air Accumulation characteristics.

The air thrust force is guided onto the unique blades of a specially designed Central Fan, causing it to spin at a relatively high rpm with a substantial torque force, while the vehicle is in forward motion. The Central Fan is connected to a wind-to-electric permanent magnet generator motor unit (WGU), that produces substantial electrical current via stator-magnet rotation. The electrical current produced is guided through electrical wires to the inside of the vehicle via a special Roof Rails and incorporated into its inner electrical charging system.

The invention is tailored from firsthand experience while putting it together, around the special characteristics of our atmospheric air: the Accumulation and Dissipation characteristics. The invention has two distinct designs. The Roof Wind Plateau, mounted on top of a vehicle, and the Front Plateau, mounted under the front hood of a vehicle. The mechanism could generate a net positive electrical current when compared to the electrical output of an electrical vehicle. Some physics laws are invoked, thus scientific driven explanations are given, explaining the data at hand that is derived from an actual prototype.

The first mechanism design, the Roof Wind Plateau (RWP) is mounted on top of a vehicle, on a specially designed Roof Rails. The Roof Rails have a hollowed interior to allow the passage of electrical wires from the RWP into the vehicle interior. The outer design of the RWP could contour in shape to a vehicle top or be squarish looking.

The Roof Plateau is composed of two mirrored units as a preferred design. Each unit has a divide between an upper section, where the Wind Generating Unit is placed, the Motor Chamber. And a lower section, where a uniquely invented fan with unique blades is securely placed, the Fan Chamber. At the front of the RWP, sits a multi-lofted loft, designed to collect a maximum amount of air, while the vehicle is in forward motion. The design maximizes the Accumulation and Dissipation characteristics of air from firsthand experimentations and observations.

The second mechanism design is The Front Plateau (FP). It is mounted at the front of the vehicle, under the front hood. Two Wind Generating Motors Units (WGU) are secured at each side of a specially designed horizontal fan and blades to maximize the capture and distribution of air thrust force while the vehicle is moving forward. The FP uses one bottom Auxiliary Air Chute.

The Front Plateau channels the air out from its Exit Vents onto the ground underneath the front of the vehicle. The faster the vehicle moves forward the more air is captured and accumulated producing significant thrust force right onto the uniquely designed fan blades. The Exit Vents of the Front Plateau directing the air out onto the ground beneath the vehicle, add to the driving stability, and weight to speed ratio of the vehicle. Both designs have front mechanical air shut offs, electronically triggered and electrically operated. The invention could produce a net positive electrical current while the vehicle is at a speed of 50 mph or more. Thus, the law of energy conservation is invoked and detailed scientific explanations are given as to how and why that is possible.

### PRIOR ART

I here reference some relative prior art I examined, under their Doc ID and date of publishing:

| | |
|---|---|
| US-20240017624-A1 | date: Jan. 18, 2024, |
| US-20230311669-A1 | date: Oct. 5, 2023, |
| US-11639100-B1 | date: May 2, 2023, |
| US-11480154-B2 | date: Oct. 25, 2022, |
| US-11286907-B1 | date: Mar. 29, 2022, |
| US-11133728-B2 | date: Sep. 28, 2021, |
| US-20200398677-A1 | date: Dec, 24, 2020, |
| US-20200101857-A1 | date: Apr. 2, 2020, |
| US-20170276120-A1 | date: Sep. 28, 2017, |
| US-20160311331-A1 | date: Oct. 27, 2016, |
| US-9446670-B1 | date: Sep. 20, 2016, |
| US-9428061-B1 | date: Aug. 30, 2014, |
| US-886357-B1 | date: Oct. 14, 2014, |
| US-20140001760-A1 | date: Jan. 2, 2014, |
| US-8371401-B1 | date: Feb. 12, 2013, |
| US-20110248666-A1 | date: Oct. 13, 2011. |

The prior art I examined, lack one or all the criteria I relied on in designing and putting together my invention, The Alternative Vehicle Energy Source:

One: Prior arts examined have poor foundational and functional design structure, not adequate to allow for sufficient air accumulation in order to attain the desired torque force needed to generate electricity via a fixed rotating fan shaft. My design takes all these points in consideration.

Two: Prior arts examined do not implement “The Half Moon” fan design that I utilize in my invention. The Half Moon design blocks the air from one half side of a specially designed blades fan, while collecting and channeling a maximum amount of air into the Fan Chamber from different angles. Some designs examined leave the blades exposed fully to incoming air, thus leading to poor and improper blade spin. Some arts rely on conventional fan designs that take too much space and are inadequate in generating torque force. This invention utilizes a specially designed fan for maximum wind cupping from various angles all at once, while the vehicle is forward motion.

Three: Prior arts examined lack the precise mechanism that demonstrate safety measures, whether against the weather elements, especially water, or against electrical hazards. Prior arts examined do not have available emergency shut off features while the vehicle is in forward motion. I do address in my invention these safety concerns.

Four: Prior arts examined do not rely, nor mention, nor take in consideration the needed science that explains, and backs said inventions. Science is needed since one of the energy conservation laws is invoked.

Most importantly prior arts examined lack the utilization of the “Accumulation and Dissipation” characteristics of our atmospheric air. My firsthand experimentations allowed for an optimum design based on deduced science based on firsthand specific data.

Five: Prior arts examined do not employ the Piston Blade design nor the Side Groove Pockets in their fan design. I employ such designs in my invention. Such designs are needed in order to take full advantage of air Accumulation characteristics while the vehicle is moving forward. The prior arts inspected, do not channel air into fans from various angles, thus the air thrust force would not be enough to produce substantial electrical output from weak torque force. My invention showcases a specifically designed fan with unique blades with Side Groove Pockets for maximum air capture resulting in robust torque force generated.

Six: Prior arts examined lack a Multi-loft Loft design and Auxiliary Air Chutes for optimum conversion of air thrust force into torque force. Utilization of multi-Auxiliary Air Chutes are needed in order to generate sufficient torque force from a fixed shaft of a rotating fan. Adequate electricity production requirements via a wind generator A/C motor or other type of alternator motors, require a strong torque force at the fan shaft. My invention is specifically designed to generate strong torque force from the air while the vehicle is in forward motion.

Seven: Prior arts examined lack the practicality, durability and especially functionality. Thus, making them unpractical, nonfunctional and unsafe for industrial use. My design has sturdiness, functionality and industrial production as core features.

### BRIEF DESCRIPTION OF FIGURES:

All the figures are scaled down form their actual measures by a scale of 1 to 6, or 1 to 8. The cross sections are enlarged by a factor of 2 in some cases.

FIG. 1: A general outside view of the mechanism with its two designs. The Roof Wind Plateau (RWP) mounted on the vehicle roof via special Roof Rails. The Front Plateau (FP), mounted under the front hood of the vehicle via Vehicle Body Mounts.

FIG. 2: The Roof Wind Plateau multi angle views. Showing the Multi-loft Loft, the Auxiliary Air Chute, the Central Fan, the Small Electric Motor, The Frontal Lip, the Wind Generator Unit, the Main Air Inlet, the Separating Shelf.

FIG. 2a: The Roof Wind Plateau from a top view. Showing the Auxiliary Air Chutes, the Exit Vent, The Frontal Lip.

FIG. 3: The Roof Wind Plateau on the Roof Rails. Showing the Main Air Inlet, the Small Central Fan, the Back Cover for the Motor Chamber, the Motor Chamber, the Fan Chamber.

FIG. 3a: The Roof Wind Plateau Lip View. Showing the Small Electric Motor, the Timing Gear, the Upper Lip Overhang, the Lower Lip, the 10 mm Rods.

FIG. 3b: The Frontal Lip Closing Mechanism. Showing the Side Bevel Gear on Timing Gear, the Bevel Gear, the Timing Gear, the Upper Lip.

FIG. 4: The Front Plateau. Showing the Wind Generating Motor Unit, WGU, the Exit Vents, the Vehicle Body Mounts, the Piston Blades, the Long Central Fan.

FIG. 4a: The Front Plateau Top View. Showing the Fan Chamber, Exit Vent, Front Guard Bracket.

FIG. 5: The Front Plateau. Showing the Bottom Auxiliary Air Chute, Main Air Inlet, the Frontal Guard.

FIG. 5a: The Front Plateau. Showing the A/C Wind Generator.

FIG. 6: The long Central Fan. Showing the Piston Blade, the Side Groove Pockets, The Motor Shaft Connector.

FIG. 7: The Long Central Fan. Showing the Side Groove Pockets, the Piston Blade.

FIG. 8: The Auxiliary Air Chute for the Front Plateau.

FIG. 11: The Roof Rails. Showing the Holes for Electrical Wires, the Electrical Conduit Holes.

FIG. 12: The Small Central Fan. Showing the Side Groove Pockets, the Piston Blade.

FIG. 12a: The Small Central Fan. Showing open view of the Piston Blade, the Side Groove Pockets, the Flange Coupling Connector.

### DETAILED DESCRIPTION OF INVENTION:

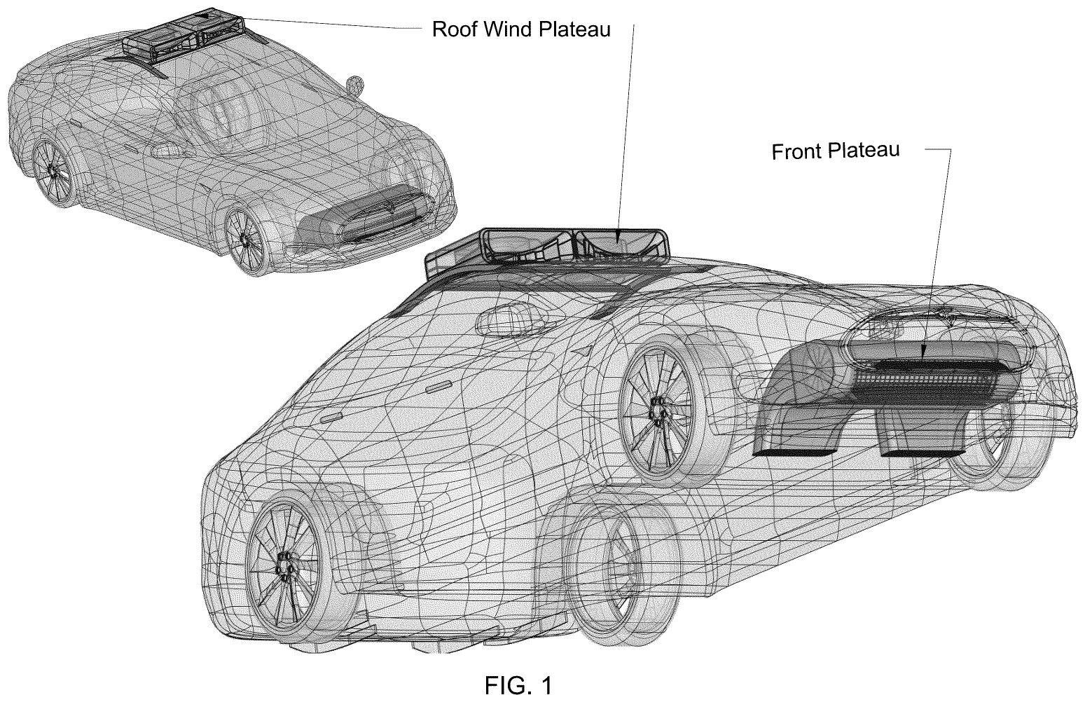

The Alternate Vehicle Energy Source invention is a vehicle mounted mechanism for the purpose of converting air kinetic energy into electrical energy while the vehicle is in forward motion (FIG. 1). The electrical current is then integrated into the vehicle charging system and used to recharge a main or an auxiliary vehicle battery or batteries, or to be stored in a portable power storage. The mechanism employs two different designs, both working with the same physics and air characteristic principals.

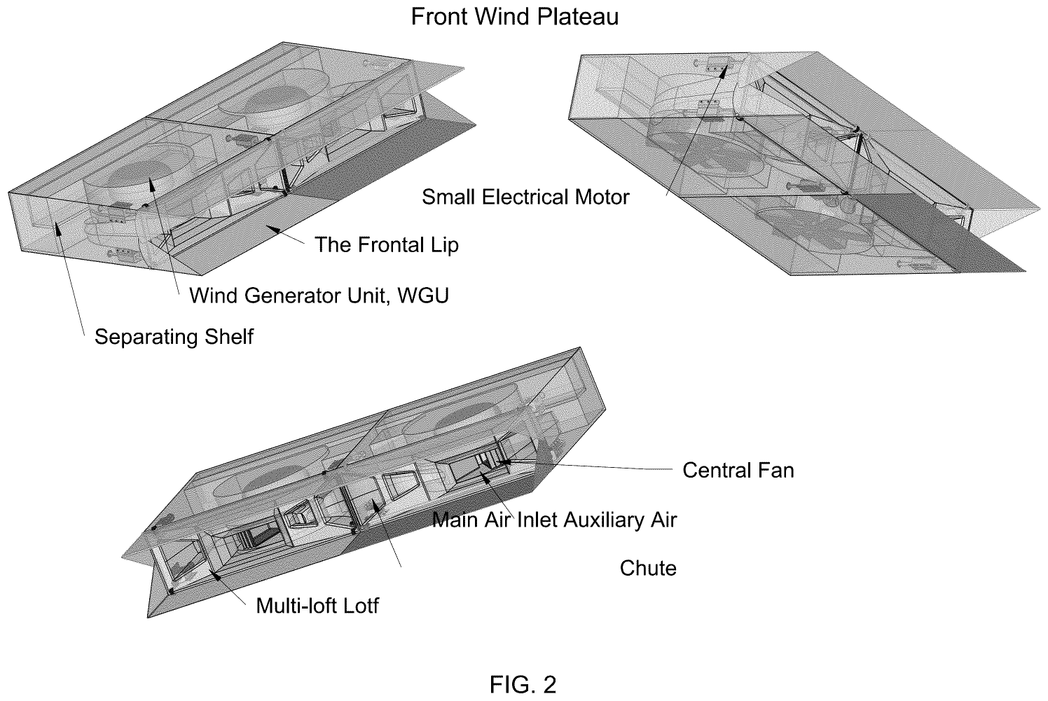

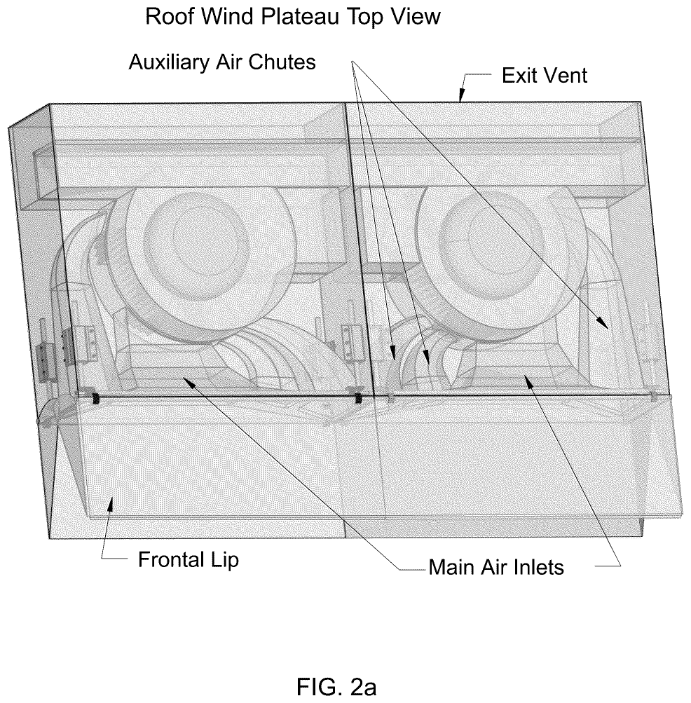

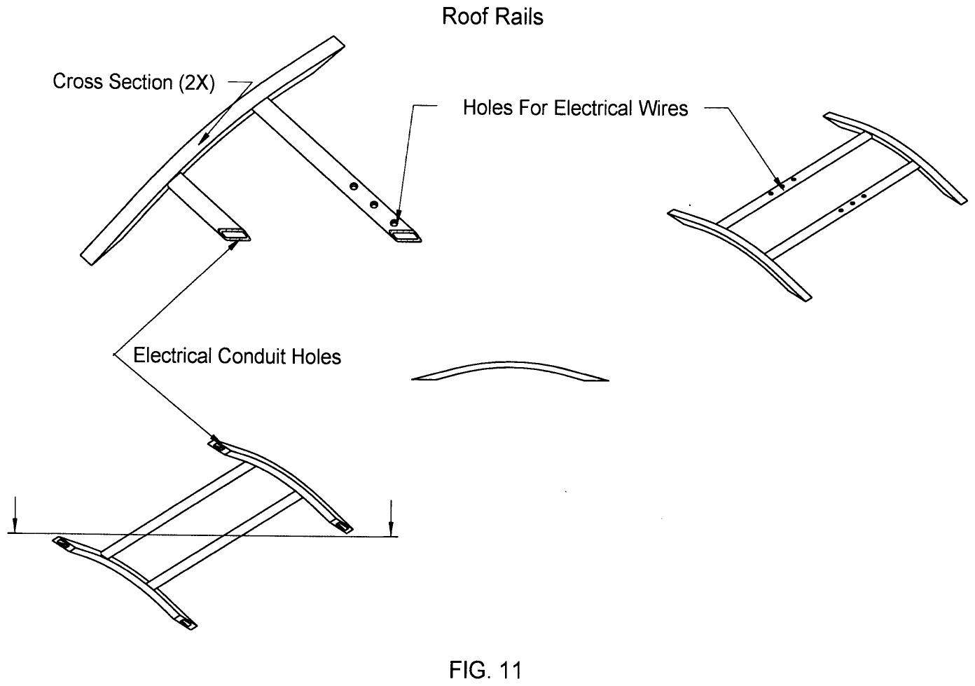

The first of the two Alternate Vehicle Energy Source invention designs is the Roof Wind Plateau, or RWP (FIG. 2, 2a, 3). The RWP is mounted on the vehicle roof or top, via a specifically designed Roof Rails (FIG. 11). The Roof Rails are hallowed on the inside to allow for the electrical wires to run through them into the vehicle's interior from the side or roof panels of the vehicle's main body frame. The Roof Rails are secured tight against the vehicle body with waterproof rubber or silicon gaskets in between the bases of the Rails and the vehicle body.

The dimensions of the RWP of the built prototype are 38 inch wide, 20 inch long and 7 inch high (FIG. 2). Those dimensions could vary based on the roof of the vehicle length and design. The RWP outer shell could be rectangular in shape, or it could be designed to contour around the roof of the vehicle. The material used to build the RWP's prototype are fiber glass, wood, plastic, aluminum and steel. The outer shell of the RWP could be fiber glass, aluminum or plastic. Plastic, metal and a fiber glass mesh were used to build the Central Fans.

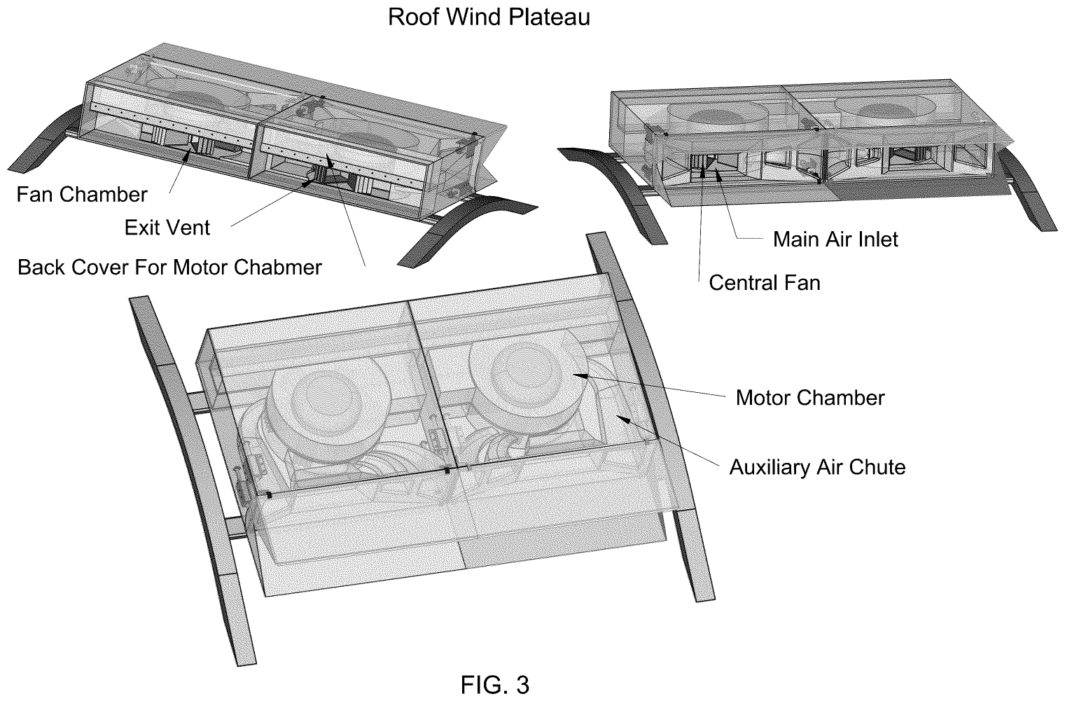

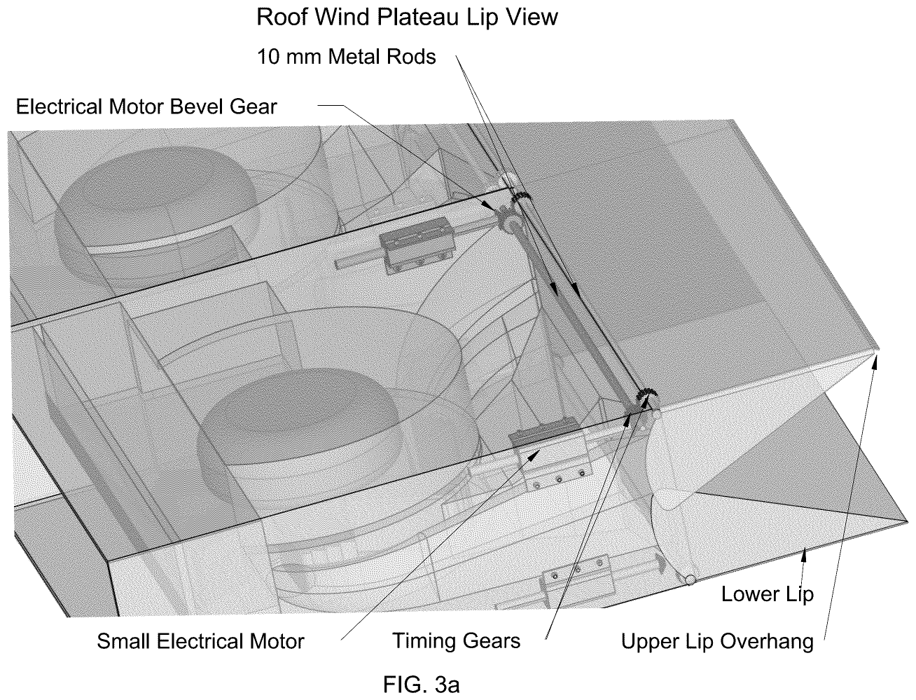

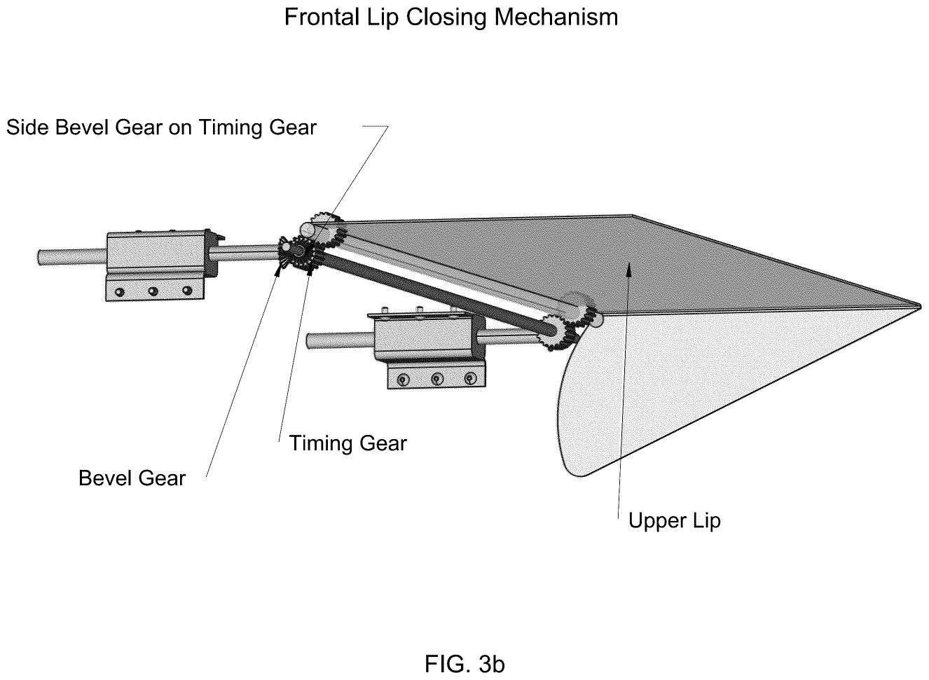

The Roof Wind Plateau is composed of two mirrored units (FIG. 2). Each unit is divided into an upper section, the Motor Chamber (FIG. 3), and a lower section, The Fan Chamber (FIG. 3). A non-electric conductive shelf separates the two sections.

The upper section contains an alternating current (A/C) brushless permanent magnet wind-to-electricity generating motor unit, or WGU (FIG. 2). The WGU has a rubber or silicon water seal gasket at the exit point of its shaft that goes down into the lower section and connects to the Small Central Fan. The water seal gasket contour around the shaft as it exits the separating shelf and protrudes vertically down. The upper section is designed to be fully waterproof, with a Back Cover for the Motor Chamber (FIG. 3).

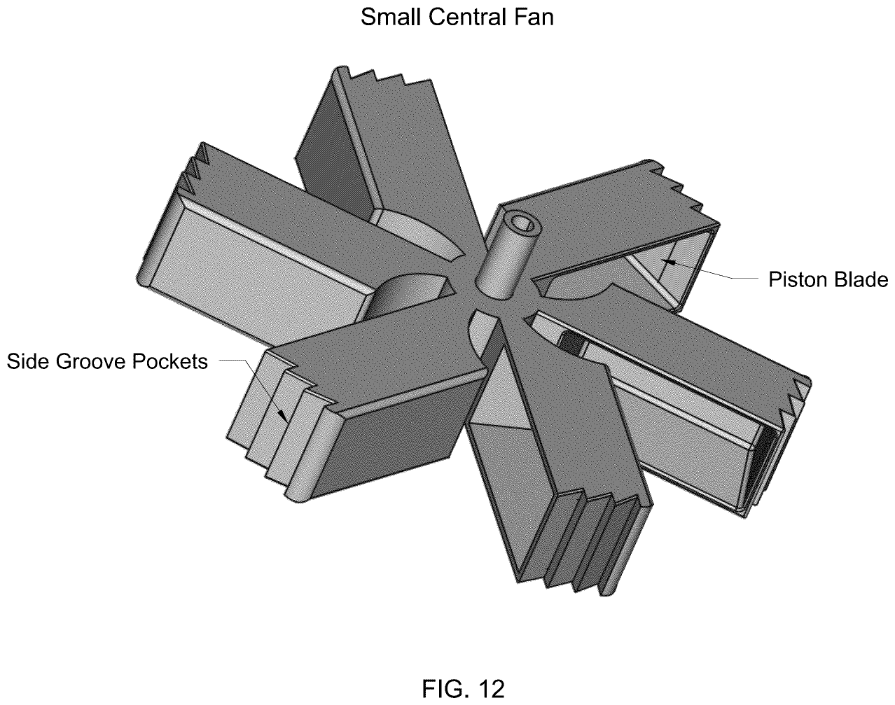

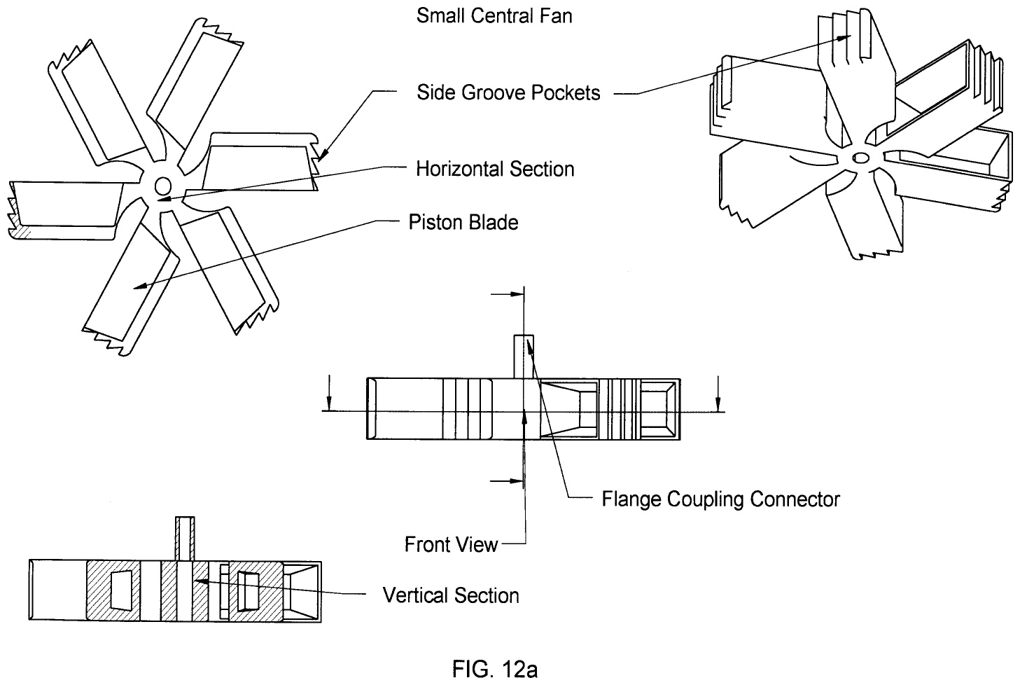

Each lower section of the two units of the RWP, has a Small Central Fan in the Fan Chamber (FIG. 12). The Small Central Fan is uniquely designed to cup the maximum amount of air while rotating. The Small Central Fan blades are uniquely designed in order to maximize the accumulation of air and are labeled in this invention as Piston Blades (FIG. 12). The Piston Blades are designed for maximum air retention. The main part of the blades faces the air at a 90-degree Flat and is designed to cup around 8 square inches of air in each blade (FIG. 12a). Each blade has Side Groove Pockets (FIG. 12a) in order to fully capture the air thrust force exerted on them form the Auxiliary Air Chutes from the side. The Small Central Fan on the bottom section, connects via a 12 mm flange coupling connector to the shaft of the WGU located in the Motor Chamber inside the upper section of each unit (FIG. 12a). The size of the flange coupling connector varies relative to the motor shaft diameter.

The front part of each unit of the RWP has one Main Air Inlet and several Auxiliary Air Chutes (FIG. 3). The Main Air inlet and Auxiliary Air Chutes are part of the Multi-loft Loft (FIG. 2). the Main Air Inlet takes on the air directly at a 90-degree angle. While the Auxiliary Air Chutes, bring in the air into the Fan Chamber from the sides. The front part of RWP employs a Half Moon configuration in its Multi-loft Loft design. The Half Moon configuration blocks the air off one half of Small and Long Central Fans and is designed to gather in and grab as much air as possible while the vehicle is in forward motion.

Using the air Accumulation characteristics, the Auxiliary Air Chutes have bigger inlets of air than exit vents to a ratio between two to ten folds, in order to generate an air squeeze or pressure (FIG. 3). The Main Air Inlets and Auxiliary Air Chutes, channel the air onto the Piston Blades of the Small Central Fan from various angles all at once while the vehicle is in forward motion. This allows for maximum gathering and distribution of air into the Fan Chamber (FIG. 2, 3).

At the very front of the Roof Plateau a safety lip-like mechanism is placed, The Frontal Lip (FIG. 3a). The Frontal Lip opens and closes either by a button command or when automatically triggered to close by the vehicle central electronic unit. When the Frontal Lip is open, the air flows in freely while the vehicle is moving forward. When it is closed, air access to the Small Central Fan is blocked. The Frontal Lip closes by both parts of the lip, the Upper Lip and the Lower Lip coming together in the middle. The Upper Lip has an overlap of ¼-in over the Lower Lip in order to prevent any air entry when the lip is closed (FIG. 3a).

The safety feature Frontal Lip stretches the width and height of the plateau and extends 8 to 12 inches forward (FIG. 3a). The Frontal Lip thus helps the accumulation of air with its design and its cupping sides. When it is closed, the air dissipates. The Frontal Lip opens and closes via Small Electrical Motors inside the plateau. There are four small electrical motors for every unit, and eight in total in the RWP. There is one small motor at every corner of the Frontal Lip of every unit for added safety in case of a malfunction of one or more motors. The motors are 6 by 2 inch and operate at low voltage. The size of the small electrical motors may vary for fitting purposes. Each side unit has its own controls where one could be open for air reception, while the other unit could be closed to air reception.

The Frontal Lip is secured to the main body through a 10 mm metal rod that stretches the length of each unit, at the Upper and Lower Lips' base (FIG. 3b). The 10 mm metal rods that hold the Upper and Lower Lips, are secured to the side walls of each unit via 10 mm zinc alloy bore pillow flange mounted bearings that allow the rods to swivel. The 10 mm rods are fitted with two 0.3-inch timing gears located ½-inch from their tip ends, with one on each end of the rods (FIG. 3b). Another 10 mm metal rod is placed ½-inch away from the first metal rod securing the Upper and Lower Lips. the second metal rod is also secured against the inner side wall of the RWP by 10 mm zinc alloy bore pillow flange mounted bearings. The second metal rod is also fitted with two timing gears that fit the timing gears on the first metal rod. The timing gears on the 2nd metal rod has bevel gears on their outer timing gear part. The bevel gears of the second metal rod fit the bevel gears at the tip end of the Small Electric Motors responsible for opening and closing the Frontal Lip (FIG. 3b).

The Motor Chamber (FIG. 3), in the upper section of the invention of RWP, has a back door for service or inspection purposes. It is designed to be waterproof and located at the back end of the Roof Wind Plateau. The Exit Vents on the Roof Wind Plateau have a gradual opening out to let the air freely flow out, thus utilizing the air Dissipation characteristics in taking advantage of the exit air thrust force as the vehicle is moving forward (FIG. 1).

When the vehicle is in forward motion, the total air captured and distributed by the Roof Wind Plateau causes the Small Central Fan to spin at a significant torque force (FIG. 3). The Auxiliary Air Chutes, contribute collectively by utilizing the air Accumulation characteristics to generate substantial thrust force from the air collected (FIG. 2a). The thrust force is channeled into the Piston Blades of the Small Central Fan (FIG. 12a), thus causing a rotation with substantial speed. Firsthand data showed that one square inch of air could rotate roughly 2000 rpm around the fixed shaft of the Small Central Fan at a speed of 55 mph. The rotating Small Central Fan attached to the Wind Generator causes the permanent magnets to spin around the copper wires on the stator arms, at the same rpm as the Small Central Fan. Thus, electrical current is generated.

The Roof Plateau is designed to self-cleans. However, a guard could be place at the front Multi-loft Loft and at the Exit Vents (FIG. 2). A guard could be made of strong material, like metal or hard plastic, and should not hinder the air entering the fan chamber, while blocking big objects from entering.

There are few variations of wind to electricity generating motors, WGU. Some have the permanent magnets in the middle of the motor, while the copper wire is on the outer part of the motor. Some other motors have the stator in the middle of the motor, while the permanent magnets are on the outer side. I have experimented with both. Both models work. I found the brushless three phase A/C wind generator motors to be easier to install and work with according to my prototype. This particular motor type allows for better fastening and securing on either of the two plateaus since all the rotation, whether the permanent magnets, or the stator, is done on the inside of the motor shell (FIG. 2). It is best to use WGU rated for high Watts at rpm between 1800 and 2400.

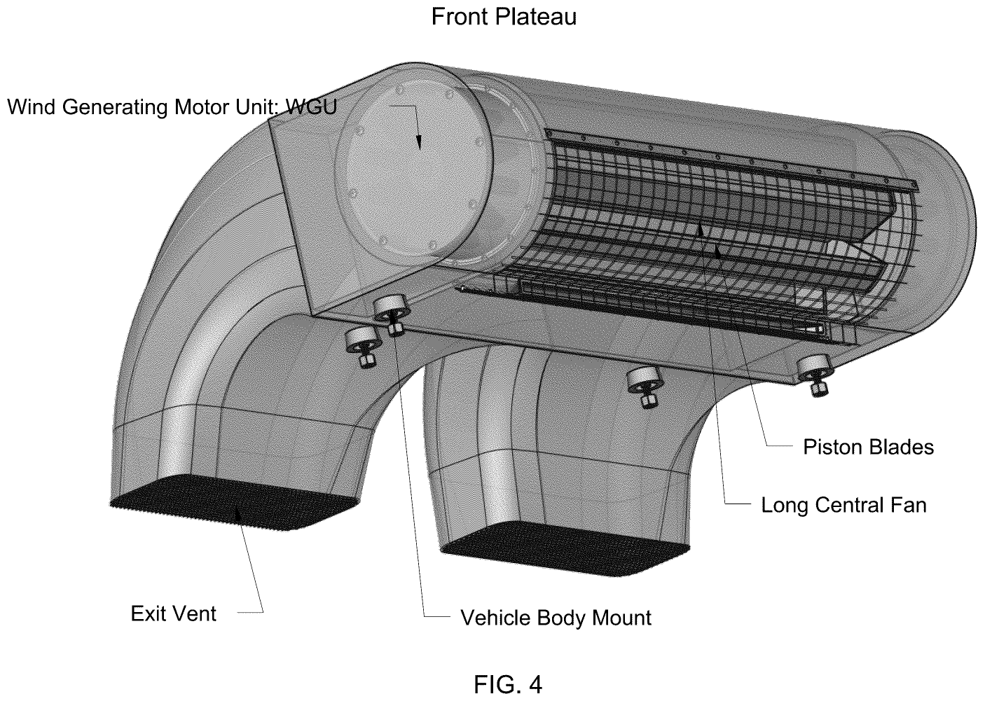

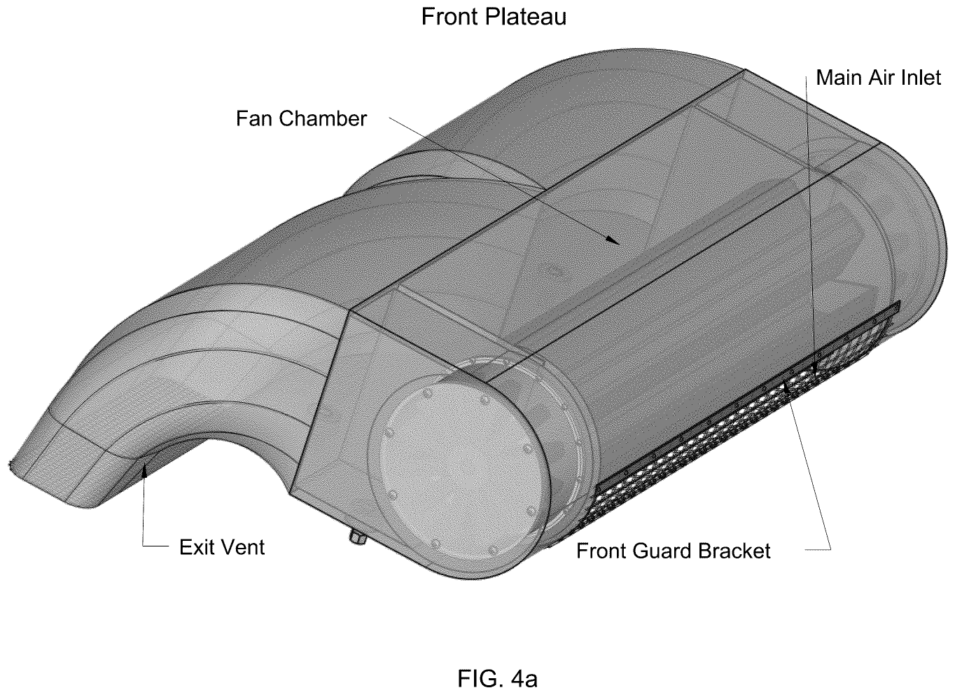

The second design of the mechanism of the Alternate Vehicle Energy Source is the Front Plateau. It is secured under the front hood of the vehicle via Vehicle Body Mounts (FIG. 4). This design is best suited for EV since often their front hood has adequate space within it for the Front Plateau (FIG. 1).

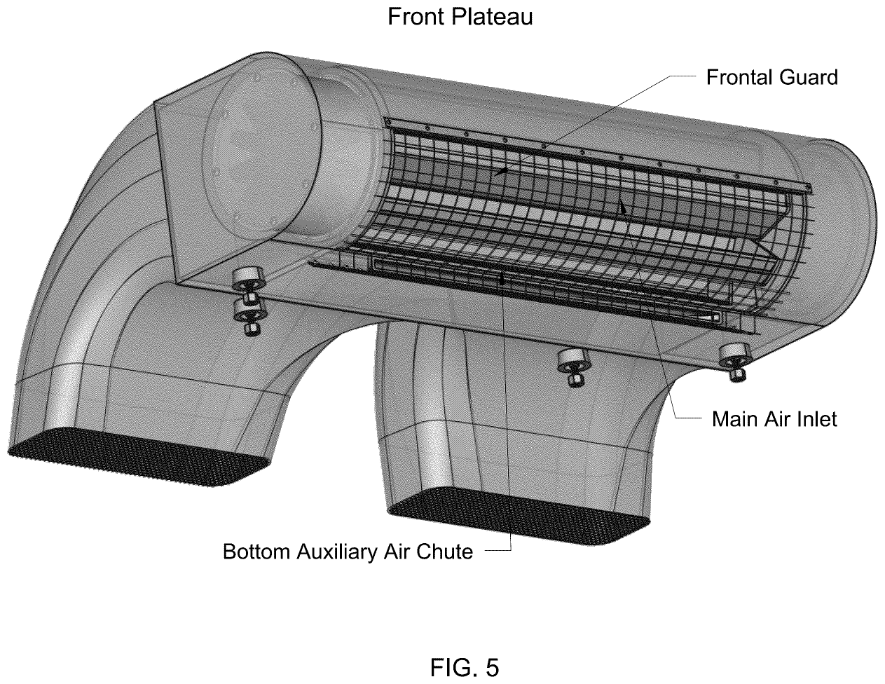

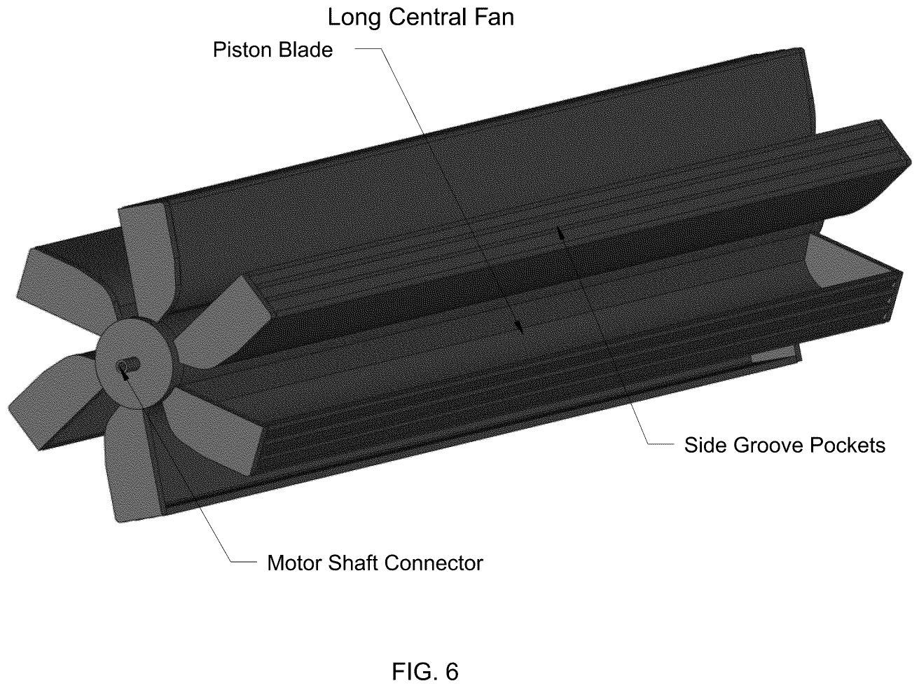

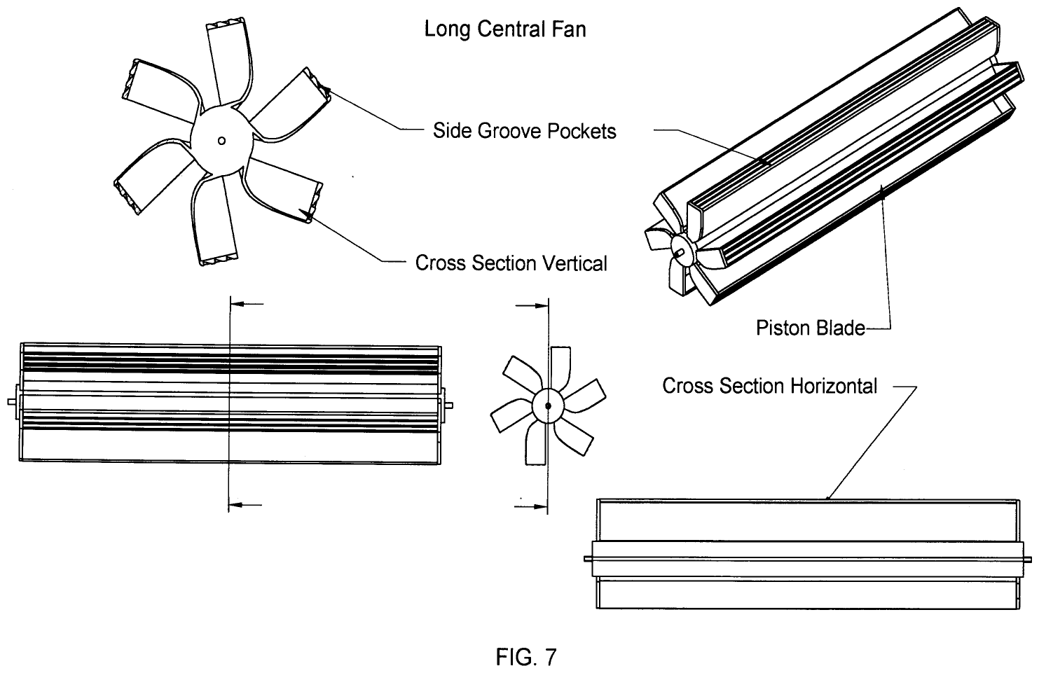

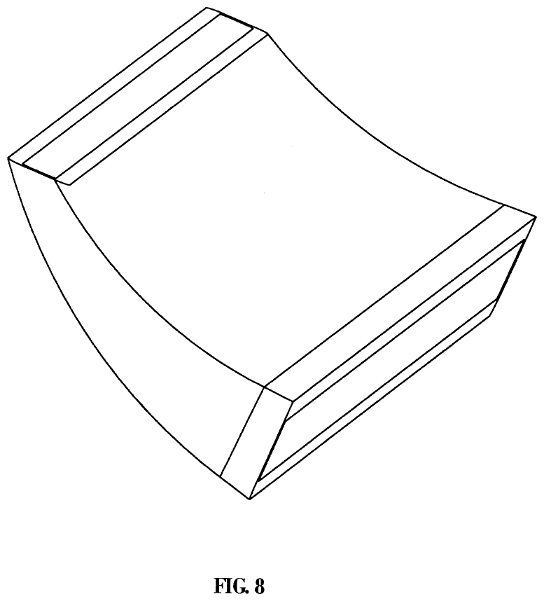

This particular design has the Long Central Fan in the middle facing the wind horizontally with the two Wind Generating motors secured at its opposite ends (FIG. 5, 5a). A waterproof dividing wall separates the two WGUs from the Long Central Fan. The air is captured from the front end opening of the vehicle as it moves forward. A protective guard is placed in front of the Long Central Fan on the outside of the apparatus and secured in by brackets, the Frontal Guard (FIG. 4). The Frontal Guard extends to protect the bottom Auxiliary Air Chute as well (GIF. 8). The Frontal Guard protects against big objects while driving, meanwhile allowing the air to enter freely into the Fan Chamber (FIG. 4a).

The electric wiring out of the WPU could be joined and directed into the vehicle charging system. Typically, the A/C electrical current, like the one generated by my invention, goes into a rectifier to either smooth or convert the A/C generated current into direct current or D/C, or to amplify the electrical current. Then the current goes into a capacitor for the electricity generated to be smoothed and regulated. It then gets integrated into the vehicle electrical charging system to charge the batterie or fill up a power storage.

Since each vehicle manufacturer has a slightly different electrical charging mechanism, the Alternate Vehicle Energy Source does not dwell in depth on the details of how the electrical current generated from air while the vehicle is forward motion, gets to the batteries or intended storage units. It is best for the vehicle manufacturer to run the electrical wiring into the vehicle charging system for safety purposes.

The Front Plateau has a shut off mechanism as well, that is operated by Small Electrical Motors thus blocking the air from reaching the Long Central Fan Chamber. The shut off contoured arm, comes down and contours around the front of the Front Plateau, thus blocking the air from reaching the Long Central Fan.

The torque force generated while the vehicle is in motion depends on the air thrust force exerted on the Piston Blades. I used the following formula calculating the force: T=0.0275×speed−(blade torque resistance). The constant 0.0275 was derived by dividing 2000 by 55. The 2000 rpm is roughly the max or high-end rotation of one cubic inch of air (Air Pixel) around the fixed point of the fan shaft at the speed of 55 mph, hence the constant I used. I did not factor gravity since one Air Pixel is relatively uninfluenced by the gravitational force.

### Preferred Method of Embodiment

The Preferred shell embodiment for either design would be from hard material that withstand the weather elements like water, and strong wind without bending. The material of choice could be hard plastic, fiber glass, aluminum, steel or faux glass.

Another method of embodiment for the Roof Wind Plateau is by lining up 2 to 4 wind-to-electricity generating motors on opposite side of the Plateau, in the upper section. The air will be entering in from only one big Main Air Inlet in the middle of the front area, as well as from the side Auxiliary Air Chutes. Such design will have a total of 4 to 8 wind generators in the upper section, coupled by 4 or 8 Small Central Fans in the lower section of the Roof Wind Plateau.

1- The Alternate Vehicle Energy Source invention herein, claims a unique design and characteristics of a vehicle mounted wind-to-electricity converting system, while the vehicle is in forward motion. The invention generates electrical current through a unique method of channeling the air thrust force into torque force applied to a specially designed fan attached to a permanent magnet wind generator motor. The system has two unique designs that were designed and constructed based on peculiar characteristics of Accumulation and Dissipation of our atmospheric air. The alternate vehicle energy source system could produce a net positive electrical energy.

2- as per claim 1, I claim the invention of the front plateau (fp), one of the two designs of the alternate vehicle energy source: The Front Plateau is mounted under the front hood of the vehicle. It captures the air from the vehicle forward motion through the front opening in the front end of the vehicle. The design abides by the system of the invention that utilizes the unique atmospheric air characteristics for Accumulations and Dissipations, as well as Auxiliary Air Chutes.

3- As per claim 1, I claim the invention of the Roof Wind Plateau (RWP), one of the two designs of The Alternate Vehicle Energy Source. Mounted on the roof of the vehicle on special Roof Rails for safety, it consists of two mirrored and uniquely designed Multi-loft Lofts, for optimum capturing and accumulating of air, while the vehicle is in forward motion. The Roof Wind Plateau directs the air thrust force coming from multi angles from the Auxiliary Air Chutes, into a uniquely designed fan, The Small Central Fan. The thrust force of air converted into torque force thus, produces substantial electrical current from a magnet-stator rotation inside the wind generator attached to the Small Central Fan below it.

4- As per claims 3, herein I claim the invention of Auxiliary Air Chutes. The Auxiliary Air Chutes extends from the front Multi-loft Loft of the RWP and into the Fan Chamber. One or more bottom Auxiliary Air Chutes work similarly in the Front Plateau. The openings of the Auxiliary Air Chutes are larger than their Exit Vents by two to ten folds. The Auxiliary Air Chutes, channel the incoming air from a forward moving vehicle form different angles into a specially designed fan. The multi angle air thrust force produces strong torque force at the base of the fan shaft. A wind generating motor connected to the specially designed fan vertically above it, produces electrical current due to the permanent magnet-stator rotation.

5- As per claim 4 of a specially designed fan, I claim the design of The Central Fan. The Central Fan is designed with its blades at a 90-degree angle with the incoming air from a moving vehicle. The Central Fan is a unique vertical fan with uniquely blades designed to simultaneously cup and capture air thrust force from four to six different sides directly while parallel to the vertical rotating shaft. There are two varying designs: a Small Central Fan, and a Long Central Fan.

6- As per claim 5 of a uniquely designed blades, I claim the invention of a fan Piston Blade that has specific air cupping capability, thus increasing its effectiveness in converting the push thrust force of air into torque force. Said fan Piston Blades are specifically designed to absorb and retain maximum air friction. The Piston Blade is measured by its air cupping size in units of one square inch of air. The Piston Blade is rectangular cup like, closed on all sides, except the part facing the incoming air thrust. There are two different designs, corresponding with the two different system designs. The Small Piston Blade ranges in depth of 1 to 4 inch, and width of 2 to 5 inch, and 3 to 5 inch long. The Long Piston Blade is 18 inch wide and 3 to 5 inch deep, and 2 to 5 inch long. The exact size could still vary from given dimensions.

7- As per claim 6, I claim the invention of Side Pocket Grooves on the fan Piston Blades' outer shell walls, parallel to the fan shaft. The Side Pocket Grooves are grooves along the outer wall of the Piston Blades. The grooves, in a set of three to six or more along the blade's sides, are angled in a way that the flat side of the groove is at a 90-degree angle with the incoming air from the Auxiliary Air Chutes. By grabbing on to the incoming air from the various air Auxiliary Air Chutes, the Side Pocket Grooves compound the torque force being generated while the vehicle is in forward motion.

8- As per claim 3, I claim the invention of a Half Moon housing design. A design that blocks off the air away from half of the Central Fan, while using the air Accumulation and Dissipation characteristics. In addition, the invention of the Half Moon design collects the blocked off air and re-channel and redirect the air thrust force as the air accumulates, while the vehicle is moving forward. Thus, resulting in max torque force at the Central Fans shafts.

9- As per claim 8, I claim the unique invention characteristics of an upper and lower housing on the Roof Wind Plateau, The Fan Chamber and the Motor Chamber. The separate chambers create a secure and hazard free area in the upper and lower zones specially form the weather elements, like water. The introduced safety measure is also applied on the Front Plateau, where the two wind generating motors are secured in the Motor Chambers, on each side of the Long Central Fan, in the Fan Chamber.

10- As per claim 3, I claim a safety shut off mechanism for the Roof Wind Plateau and the Front Plateau, the Frontal Lip. The Frontal Lip on the Roof Wind Plateau has an upper and a lower Lip parts. When the two Lip parts are open, air flows in freely. When the two Lip parts are closed in, the air is blocked from reaching the Small Central Fans. The Frontal Lip is operated via Small Electrical Motors mounted on the side walls of the RWP. The Small Motors have bevel gears tips that match the side bevel gears on the timing gears on the metal rods connecting the Lip body to the body of the RWP. On the Front Plateau, the Frontal Lip is in a form of an extended arm that comes down and contour to the front part of the plateau facing the incoming air from the front. The safety Frontal Lip feature is electrically operated and could be electronically triggered via a button, or automatically triggered by the vehicle main computer unit.

11- As per claim 1, I claim that the Earth atmospheric air has unique Accumulation characteristics that my invention helps unveil. The Accumulation characteristics of air are relative to the vehicle (or wind) speed, the max accumulation rate of the air molecules of Nitrogen (N2) and Oxygen (O2), as well as the max difference in circumference between the opening and the exit end along with the angle, girth and length of air chutes. There is a constant number at which the air molecules of Nitrogen and Oxygen stop accumulating and start dissipating, with the impact surface of air having zero permeability.

12- As per claim 1, I claim the unique Earth atmospheric air Dissipation characteristics that my invention helps to develop. Such air characteristics have to do with the angle of impact, the degree of slope, and the friction of the slope's surface. The Dissipations characteristic also pertains to the increments of angles commensurate to girth, at which to convert a 90-degree angle, through series of 45-degree angle bends to avoid loss of air thrust. The Dissipation characteristics of air could be utilized in favor of momentum as well. The fine line between the max Accumulation, and the start of Dissipation, could be calculated based on speed, girth, narrowing ratio of air channel between the air inlet and the exit vent. When the Accumulation of air molecules of Nitrogen and Oxygen reach the max limit according to conditions, Dissipation begins.

13. As per claim 6, 1 claim therefor that an air unit of 1 inch square, is called an Air Pixel, and can be used as a measuring unit of air kinetic energy. It is used to measure the Piston Blades holding capacity. It is also used to measure the net positive kinetic energy present in the air and how it relates to electrical current. One Air Pixel rotates roughly 2000 rpm around a fixed fan shaft with a 3-inch-long blade at 55 mph according to my data.

14- As claim 13 demonstrates that Air Pixels units are used to calculate and measure the conversion of wind thrust force into electrical energy through torque-forced motion, I claim the presence of a net positive kinetic energy in the air. The data my invention produced forth as of claim 1, shows that a net positive kinetic energy is constantly present in still air. A net positive kinetic energy in the air proves that net positive energy can be generated from air friction. A net positive constant energy presence indicates that the Earth's atmosphere is not in a closed system state. The data attained indicates that our echo system is not isolated from the Universal Plasma. Therefore, the energy conservation laws do not apply to the atmospheric air, and thus a net positive electrical energy could be attained from it.

15- As claim 14 shows that the Earth atmosphere in not in a closed system according to data at hand, I thus claim that there must exist a unique and orderly permeability between the Earth's five outer layers of our atmosphere and the Universal Plasma on the other hand. The five outer layers of our atmosphere: Troposphere, Stratosphere, Mesosphere, Thermosphere and Exosphere, must act permeably in an orderly and a peculiar manner with the Universal Plasma, for our atmosphere not to be in a closed system state.

16- As claim 15 points to the permeability between our atmosphere outer layers and the Universal Plasma, I here claim that such permeability is what keeps the ratio of Nitrogen (N2) and Oxygen (O2) steady and equally distributed all around the Earth's contour in our atmosphere. Such permeability is probably the reason why the Nitrogen to Oxygen ratio, of about 4 Nitrogen particles to 1 oxygen particle, is a steady constant. Nitrogen's plentiful presence in our atmosphere is possibly the result of our atmosphere peculiar permeability with the Universal Plasma.

17- As claim 16 shows, the Nitrogen-oxygen steady ratio in the air of 78% and 21% respectively, indicates that the composition of our air is the product not the driver of our outer atmospheric shells' permeable interaction with the Universal Plasma. Therefore, our inner atmosphere retains a constant net energy charge. Due to the fact that our atmosphere retains a steady Nitrogen-Oxygen ratio as of claim 16, and a positive net energy presence as of claim 14, therefore I claim that the Universal Plasma interaction with our atmosphere is driven inwardly, from the outside in.

18- As claim 17 shows that due to the equal interaction and exact distribution of pressure exerted on our atmosphere from all sides, I claim that the Universal Plasma reacts to the Earth's mass actively. That recognition is marked by the plasma engulfing, griping and fully cupping the Earth's round mass equally and precisely from all sides. Such complete engulfment and firm grip on the Earth's globe, is probably the engine that keeps the Earth on its perpetual path.

19- As claim 18 shows, I here claim that the plasma pressure exerted inwardly on our globe equally and precisely from all sides, creates a controlling grip at the center point of our round globe. Likewise, the Universal Plasma creates a controlling grip at the center of all round masses in the Universe, commensurate with their organic mass, structure and composition, whether suns or planets. The plasma-atmospheric interaction is driven from the outside, and such pressure driven interaction is equal and precise form all sides contouring to the curves of the Earth's roughly round mass.

20- As claim 19 shows that plasma-atmospheric pressure or interaction is driven from the outside in, and is equally and precisely distributed from all sides of the Earth globe, and due to the fact that such controlling grip is exerted on all round masses throughout the universe due to their orderly, non-chaotic march, I claim an indication that the Universal Plasma is either driven by, or possesses some sort of intelligence. Order requires intelligence, otherwise it descends into a self-demolishing chaos with planets and suns smashing each other into smithereens. Thus, the universal harmonious and orderly march must have a single-source intelligence at its plasmatic core. Intelligence is necessary for order to be manifested. Order mandates a preexisting intelligence in order to be orderly; otherwise, it descends quickly into an obliterating chaos.
